(19) United States
(12) Patent Application Publication
(10) Pub. No.: US 2007/0202289 A1
(43) Pub. Date: Aug. 30, 2007

(54) Array of self supporting thermally conductive insulator parts having a perforated outline surrounding each part to facilitate separation and a method of packaging

(76) Inventors: Robert Kranz, Cleveland, OH (US); Kyle Gay, Cleveland, OH (US); Kevin Bohrer, Cleveland, OH (US)

Correspondence Address: Eugene Lieberstein, Esq.;Anderson Kill & Olick, P.C., 1251 Avenue of the Americas, New York, NY, 10020, US

(21) Appl. No.: 11/364,680

(22) Filed: Feb. 27, 2006

(51) Int. Cl. G09F 3/00

(52) U.S. Cl. 428/43

(57) ABSTRACT

An array of self supporting thermally conductive insulator parts disposed in a sheet or roll of a thermally conductive material with each part having a perforated outline comprising a plurality of spaced perforations surrounding each part to substantially define its geometry and for facilitating the manual separation of each part from the array and a method of fabricating the array.

### FIELD OF INVENTION

This invention relates to an array of self supporting thermally conductive insulator parts having a plurality of spaced apart perforations surrounding each part for forming an outline of the part and for facilitating the manual separation of each part from the array with the parts preferably being interconnected to one another without a common liner at one or more selected points of contact and to a method of packaging.

### BACKGROUND OF THE INVENTION

Microelectronic components, such as semiconductors or semiconductor packages including integrated circuits, generate substantial heat. This heat must be removed and quickly to maintain the component's junction temperature within safe operating limits. To efficiently and effectively remove heat from a microelectronic component a thermally conductive insulating part is used in combination with a heat sink. The heat sink spreads and transfers the heat to the ambient atmosphere and the thermally conductive insulating part functions as an interface disposed between the microelectronic component and the heat sink. The selected interface and the intrinsic and contact thermal resistance at the interface junction between the heat generating component (e.g. silicon ic chip) and the heat sink controls the degree of heat transfer.

Since the microelectronic package and heat sink do not generally have smooth and planar surfaces a relatively wide and irregular gap may exist between the surfaces of the microelectronic component and heat sink. Accordingly, a thermally conductive insulating part must be selected to fill the gap and provide minimal intrinsic and contact thermal resistance at the interface junction. The preferred thermally conductive insulating part is a material having reasonable surface flatness, is somewhat elastic and possesses a high tensile and mechanical strength with desirable electrical insulation properties and is thin but of adequate thickness to fill the gap. The preferred total thickness for the thermally conductive insulating part should be between 1 and 12 mils. The geometry of the reasonably flat surface may vary although a rectangular, square or circular geometry is typical with the surface area being compatible in size to the surface area of the abutting heat sink.

The desired characteristics of tensile strength, mechanical strength, electrical insulation properties and the requirement for the surface to be reasonably flat eliminates the selection of known thermally conductive materials which are not solid at least at room temperature. Moreover, if the tensile and mechanical strength requirements for the thermally conductive insulator parts are high the parts need to be self supporting and cannot be packaged on a liner for common handling even if the liner is disposable or with the use of an adhesive backing. In addition, for applications where the parts must be very thin to provide reduced thermal resistance but must also need to have high mechanical and tensile strength requirements the parts should be self supporting.

Currently the thermally conductive insulating parts which satisfy all of the above characteristics and requirements are formed by punching or cutting individual parts out from sheets or rolls of a thermally conductive material otherwise meeting the desired characteristics, properties and thickness indicated above. The punching die or tool is shaped to form the desired geometry for each part. The result is a multiplicity of loose individual small thin parts which may number in the millions. The handling of such parts without causing damage to the parts is time consuming, difficult and costly both to the manufacturer, processor and customer. The parts are also difficult to inventory and count. Presently, the parts are dumped into a box or bag forming a container for a given number of parts. The number of such parts is determined by counting or weighing. Unfortunately, since the thermal material parts have thickness tolerances which significantly affect the weight of each part additional weight is needed to control at least the correct minimum number of parts in the container. For the customer to verify the accuracy of the number of parts in the container the customer must recount the parts before dispensing them to the production line. This is also very time consuming and is a laborious task which adds to the cost of the assembled microelectronic component and heat sink.

A method of packaging has been discovered in accordance with the present invention for forming an array of self supporting thermally conductive insulator parts comprising perforating a sheet or roll of thermally conductive material to form a multiplicity of spaced apart perforations with each part surrounded by a plurality of perforations forming a perforated outline of each of the parts and with each of the parts preferably being interconnected together at one or more selected points of contact in the absence of a common liner. The perforated outline defines the geometry of the parts.

### SUMMARY OF THE INVENTION

An array of self supporting thermally conductive insulator parts with each part being surrounded by a plurality of spaced apart perforations for facilitating the manual separation of each part from the array. In the preferred embodiment each part is interconnected to another part at one or more selected points of contact forming a common matrix of parts without a liner. The plurality of perforations also defines the geometry of the parts.

The array of self supporting thermally conductive insulator parts is formed in accordance with the method of the present invention comprising the steps of forming a sheet or roll of thermally conductive insulating material having a base layer in the form of a film or fabric of an inorganic or organic material composition and a polymeric coating composition including particles of a metal or metal oxide on at least one side thereof and perforating the sheet or roll to form a multiplicity of perforations in the sheet or roll such that a plurality of spaced apart perforations form a perforated outline of each respective part. In the preferred embodiment each sheet is perforated such that the parts are interconnected at one or more selected points of contact and in the absence of a common liner. The base layer is preferably a film composed of a polyethylene or a polyimide and the coating is preferably composed of a polymeric resin with particles of alumina or a phase change material “PCM” as is commonly known to those skilled in the art such as a composition of a wax preferably paraffin wax and a metal oxide preferably zinc oxide.

### BRIEF DESCRIPTION OF THE DRAWINGS

Other advantages of the present invention will become apparent from the following detailed description of the invention when read in conjunction with the accompanying drawings of which:

FIG. 1A is a top view of the layout for die cutting a conventional sheet of thermally conductive insulating material to produce a multiplicity of parts as illustrated in FIG. 1B;

FIG. 1B illustrates a sampling number of conventional thermal insulator parts die cut from the sheet shown in FIG. 1A;

FIG. 2A is a bottom view of a perforated steel rule die for forming a perforated array of interconnected self supporting thermally conductive insulator parts in accordance with the preferred embodiment of present invention with each part having a rectangular geometry;

FIG. 2B is a cross sectional view of a section of the perforated steel rule die of FIG. 2A to form the perforated array of parts in accordance with the present invention;

FIG. 3A is an exploded view of a section of a sheet of thermally conductive insulator material which has been perforated using the perforated steel rule die of FIG. 2A to show a typical perforated pattern where the perforations are uniform in length (size);

FIG. 3B is an exploded view of another perforated format in accordance with the present invention;

FIG. 3C is another exploded view of yet another perforated format in accordance with the present invention;

FIG. 4A is a bottom view of a perforated tool die similar to FIG. 2 for forming a perforated array of self supporting thermally conductive insulator parts of circular geometry;

FIG. 4B is a bottom view similar to FIG. 4A of a punching tool with nicks to provide gaps for forming a perforated array of self supporting thermally conductive insulator parts of circular geometry with each interconnected at points of contact represented by the nicks in the tool;

FIG. 5 is an exploded view of a perforated format of parts formed in accordance with the present invention on a continuous roll as opposed to sheets; and

FIG. 6 is a diagrammatic illustration of a sheet of thermally conductive insulating material showing an additional perforated manually removable donut hole in the sheet for screw attachment or electrical connection.

### DETAILED DESCRIPTION OF THE INVENTION

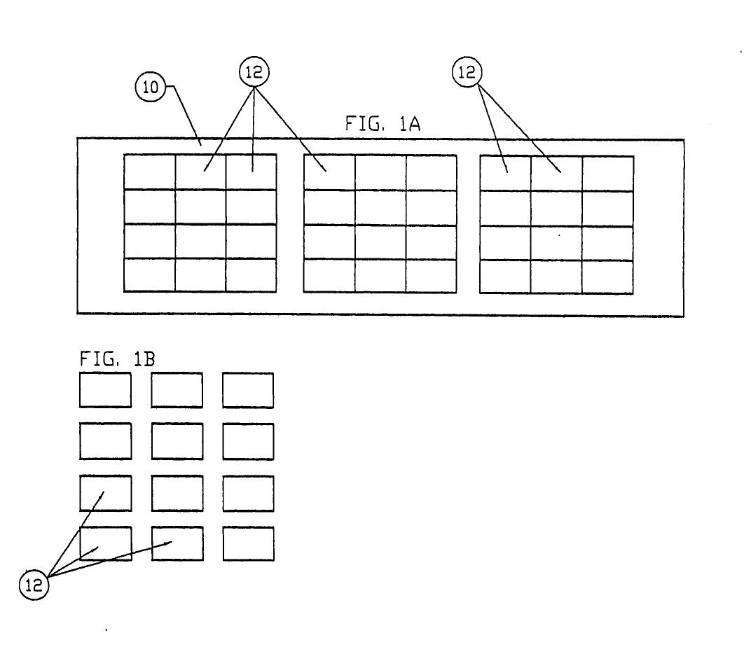

Thermally conductive electrical insulating parts are currently formed using a conventional punch or steel rule die (not shown) designed to provide a tool cutting pattern as shown in FIG. 1A which will simultaneously cut out a multiple number of identical parts 12 from a sheet of material 10 or from a roll of material (not shown). The standard die completely cuts through the sheet of material 10 to form the multiplicity of single parts 12 as is shown in FIG. 1B.

If the material composition of each of the parts 12 is to be suitable for use as a thermally conductive insulating material it must possess properties of high thermal conductivity and have high tensile and mechanical strength. The mechanical strength of the thermal material can be achieved using either a fabric or a film for the thermally conductive material. The fabric can be either inorganic such as a fiberglass or of an organic composition such as a polyester. The thermally conductive insulating material may include a base and a coating on either or both sides of the base with the base represented by a film having a preferred composition of a polyethylene terephthalate or a polyethylene naphthalate or a polyimide. The composition of the base optimizes the electrical insulation properties of the material and provides tensile strength. An example of a preferred material would be a polyethylene naphthalate (PEN) having a tensile strength of 38 kpsi and a thickness of 0.025 mm. The coating on the base film may be composed of a polymeric resin such as, for example, a platinum cured silicone resin with particles of alumina of between 18 V % and 82 V % and the alumina particle size should average between 2.5-3.0 microns. The coating may have a thickness of between 0.01 to 0.05 mm on each side of the base film. Alternatively, the coating can be composed of a phase change material “PCM” such as a composition of wax, preferably paraffin wax and a metal oxide preferably zinc oxide. A preferred composition for a coating of PCM would be 65% zinc oxide having a particle size of between 0.1 to 2.0 microns and 35% paraffin wax.

The preferred total thickness of the thermally conductive insulating part 12 should be limited to between 1 and 12 mils to provide desirable reduced thermal resistance and for use in many desired thermal interface applications each part 12 should be solid, at least at room temperature, and have a reasonably flat surface compatible in size to the surface area of the abutting heat sink although the geometry of the surface of the thermal interface material part 12 is not critical and may, for example, be rectangular, square or circular in configuration. However, the size and reduced thickness requirements for the parts 12 create packaging problems in terms of handling, counting etc., which increases the cost of assembly and increases assembly time during processing.

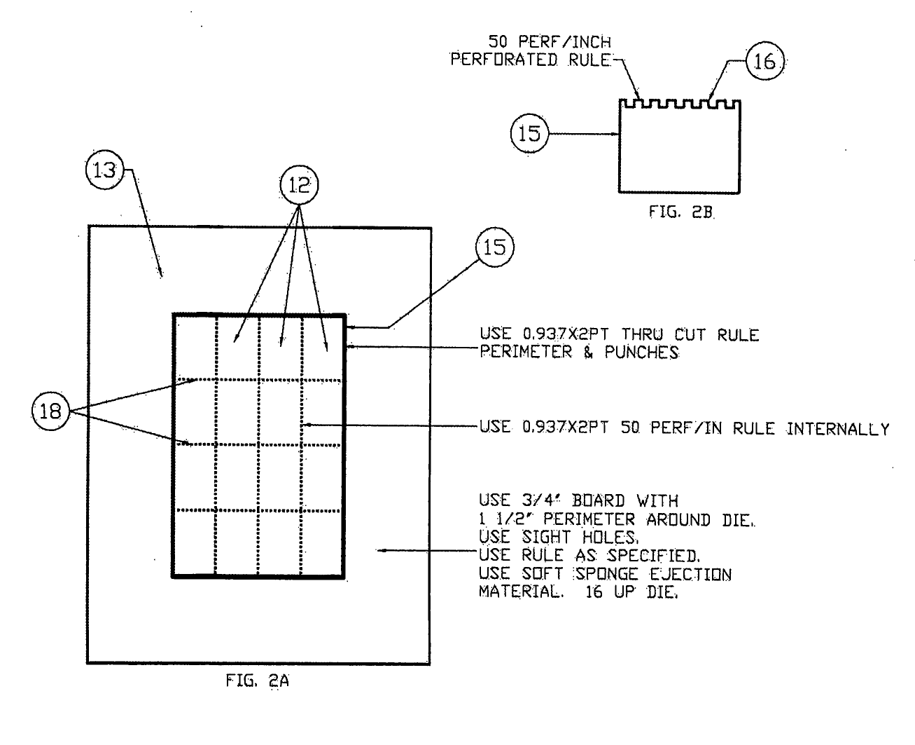

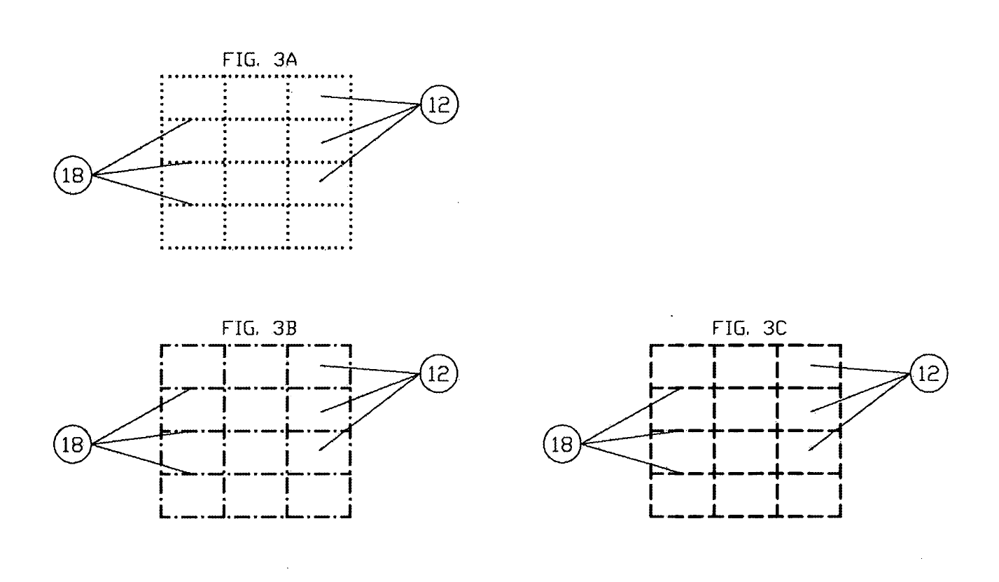

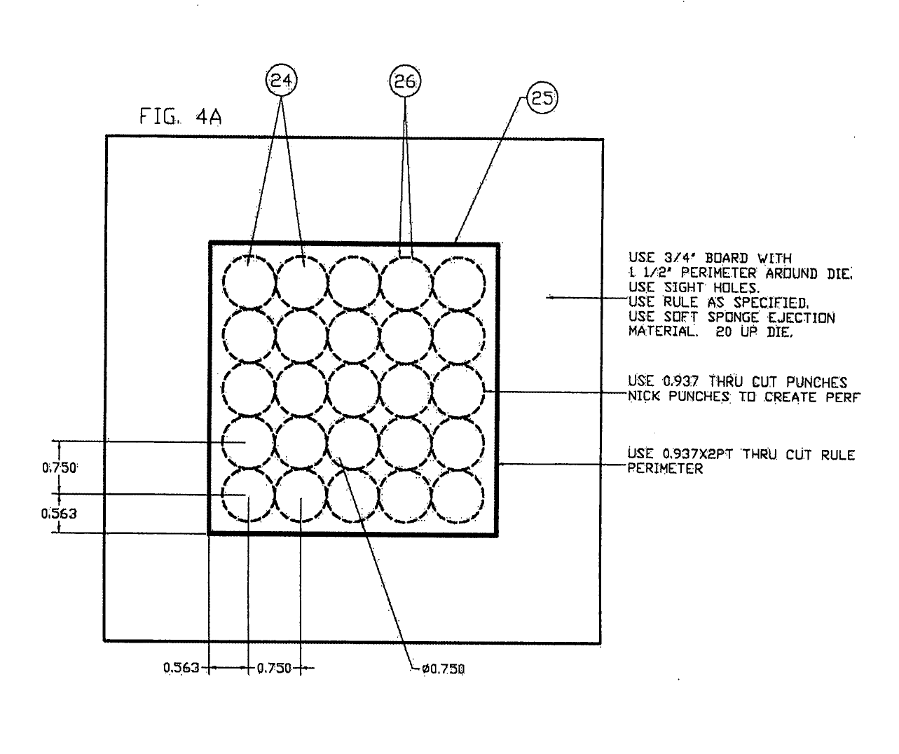

This packaging problem is overcome in accordance with the present invention by forming an array of self supporting thermally conductive insulator parts in a sheet or roll of thermal insulator material with the parts being preferably interconnected in the absence of a liner and being manually removable from the array preferably one at a time. The array is formed by perforating the sheet or roll of thermal insulator material with each part having a perforated outline surrounding the part to substantially define its geometry and to facilitate its separation from the other parts. This is accomplished using a punch or cutting rule die 15 as shown in FIGS. 2A and 2B, preferably having perforated edges 16 to form perforations 18 surrounding each part 12 in the material 10 as shown in FIGS. 3A, 3B and 3C respectively. The perforations 18 should preferably extend through the material to form open spaces in the material 10 in a pattern defining the array of parts with each part having the desired geometry for the part 12 but spaced far enough apart from one another so that each part 12 is self supporting and interconnected without any support liner or cover needed. The spaced perforations 18 facilitate the manual separation of each part 12 from the other parts in the material array.

The perforated steel rule die 15 shown in FIG. 2A includes a board 13 of, for example, ¾ inch with a perimeter, of, for example, 1½ inch around the die 15. FIG. 2B is a cross sectional view of a section of the die 15 showing the perforated edges 16 which may contain, for example, 50 perforations per inch i.e. a perforation length of 0.5 mm.

The geometry of the parts 12 and number of perforations 18 will determine the number and points or area(s) of contact between the parts 12. The perforations 18 need not be linear in dimension or uniform or of any given size or length. The perforated die tool can produce different patterns for the array of parts in a sheet 20 or roll (not shown) with a substantially rectangular geometrical pattern being demonstrated in the exploded views of FIGS. 3A-3C having different perforation sizes and lengths. The perforations 18 can be consistently spaced apart as shown in FIG. 3A or more material may be cut out relative to the amount of uncut material as shown in FIGS. 3B and 3C. The application will determine the ratio between the uncut spaces and the size of the perforation. For example, a 1 mil base film of sheet material 20 may require more uncut material than a 3 mil thickness. The ease in which the parts 12 of the material 20 can be separated is a critical factor in deciding the material length between perforations and the perforation sizes. Clearly, if the sheet of material 20 cannot be handled without it falling apart, then the amount of uncut material must be increased. Alternatively, if the parts 12 cannot be manually separated from the sheet 20 with ease and speed without tearing into the part itself, then the amount of uncut material will need to be decreased.

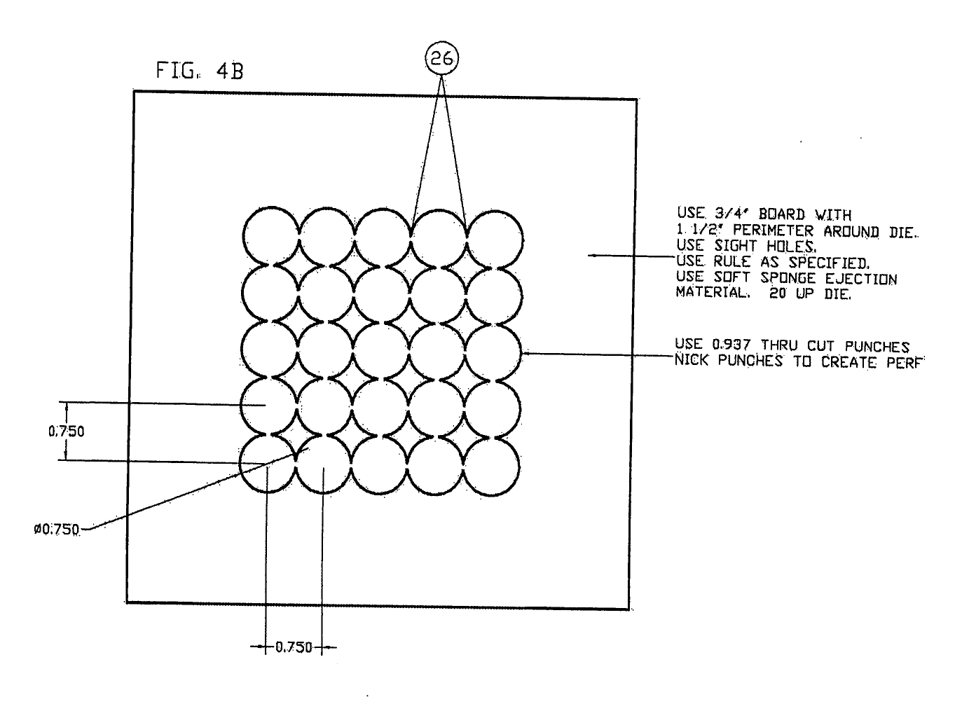

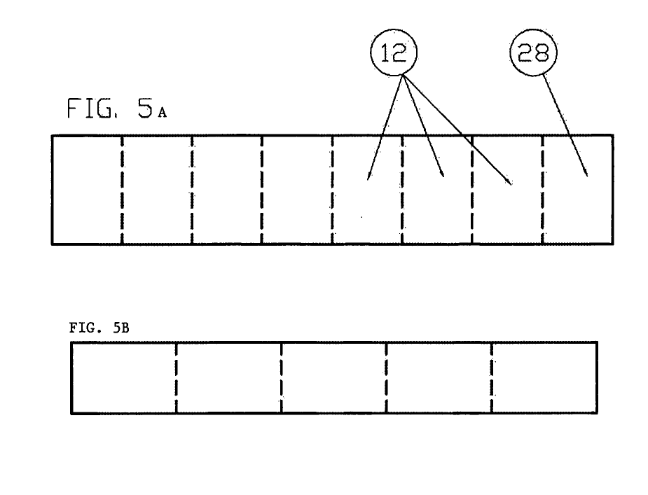

The perforated parts 12 can be formed in any desired geometrical pattern including an array of parts each having a circular geometry. To form a circular geometry a cutting or punching tool 25 as shown in FIG. 4A or FIG. 4B is selected with a circular cutting die using either perforated edges or nicks in each of the circular die cutting arms to form circular parts 24 of circular geometry. The circular parts 24 can be separated from one another as shown in FIG. 4A with each part 24 having spaced apart perforations 26 surrounding the part and defining the outline of the part. Alternatively, each part 24 is in contact through at least one or more points of contact to other parts 24 so that all of the parts are interconnected with the points of contact represented by the perforations 26 as shown in FIG. 4B. The perforated tool 25 of FIG. 4 may be the same as the cutting tool 15 of FIG. 2 except for using circular perforated edges or nicks in the cutting die.

The perforated parts 12 or 24 can be provided in sheets or rolls. FIG. 5 is an exploded view of a perforated format of parts 12 formed in accordance with the present invention on a continuous roll 28. An array of self supporting thermally conductive insulator parts formed on a continuous roll 28 instead of a sheet permits a customer to minimize the number of part configurations to be placed into inventory.

The present invention provides the parts 12 and 24 in the form of either a sheet 20 or a roll 28 which allows for accurate counting of the parts based simply upon the number of parts on each sheet or roll. This speeds up handling, counting and inventory procedures. Moreover, the sheets can be stacked to minimize part damage or disfigurement. The sheets can be tightly packaged to prevent movement against each other and/or an interleave sheet can be added to prevent blocking.

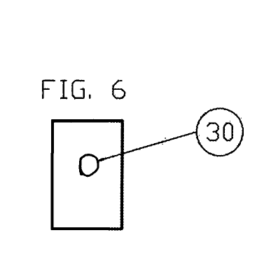

It may be desirable to include one or more punched holes in the parts for screw attachment or electrical connection. In the present invention this may be accomplished by punching one or more perforations 30 in a defined geometrical configuration such as a circle in the sheet 20 or roll 28 as shown in FIG. 6 which is readily removable from the sheet 20 or roll 28 to form one or more openings or holes for purposes of screw attachment or electrical connection. The removal of the perforated hole(s) in the sheet may also be accomplished by simply shaking the sheet.

What we claim is:

1- An array of self supporting thermally conductive insulator parts disposed in a sheet or roll of a thermally conductive material with each part having a perforated outline comprising a plurality of spaced perforations surrounding each part to substantially define its geometry and for facilitating the manual separation of each part from the array.

2- An array of self supporting thermally conductive insulator parts as defined in claim 1 wherein said perforations form a predetermined pattern of parts in said material of any desired geometry.

3- An array of self supporting thermally conductive insulator parts as defined in claim 2 wherein said perforations fully extend through said part.

4- An array of self supporting thermally conductive insulator parts as defined in claim 3 wherein said array of parts are interconnected to other parts in said array at one or more selected points of contact in the absence of a liner.

5- An array of self supporting thermally conductive insulator parts as defined in claim 4 wherein the perforations are uniform in length and are spaced equally apart.

6- An array of self supporting thermally conductive insulator parts as defined in claim 4 wherein the perforations are non-uniform in length and are spaced equally apart.

7- An array of self supporting thermally conductive insulator parts as defined in claim 4 wherein said array of parts have a thickness in the range of between 1 and 12 mils.

8- A method of forming an array of self supporting thermally conductive insulator parts comprising the steps of forming a sheet or roll of a thermally conductive insulating material having a thin base layer in the form of a film or fabric of an inorganic or organic material composition having at least two sides and a coating on at least one side thereof composed of a polymeric composition including particles of a metal or metal oxide wherein said method further comprises perforating said sheet or roll of thermal insulator material to form a multiplicity of perforations in a pattern defining said array of parts with each part having a plurality of spaced apart perforations surrounding the part to form an outline of said part and for facilitating the manual separation of each part from the array.

9- A method as defined in claim 8 wherein said array of parts are interconnected to one another at one or more selected points of contact.

10- A method as defined in claim 9 wherein said base layer comprises a polyethylene or a polyimide.

11- A method as defined in claim 10 wherein coating is a composition of a polymeric resin with particles of alumina.

12- A method as defined in claim 10 wherein coating is a composition of a phase change material.

13- A method as defined in claim 12 wherein said phase change material is a paraffin wax and a metal oxide.
